(19) United States
(12) Patent Application Publication
(10) Pub. No.: US 2026/0276773 A1
(43) Pub. Date: Sep. 17, 2026

(54) SOUND DIRECTION SENSOR-BASED ACOUSTIC CAMERA AND RELATED SYSTEMS AND METHODS

(71) Applicant: Toyota Motor Engineering & Manufacturing North America, Inc., Plano, TX (US)

(72) Inventors: Taehwa Lee, Ann Arbor, MI (US); Ziqi Yu, Ann Arbor, MI (US); Xiaopeng Li, Ann Arbor, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 19/079,562

(22) Filed: Mar. 14, 2025

(51) Int. Cl. G01S 3/84; G01S 3/802; G06T 11/00

(52) U.S. Cl. CPC G01S 3/84; G01S 3/802; G06T 11/00

(57) ABSTRACT

Disclosed herein are sound direction sensor-based acoustic cameras and related systems and methods. In one example, a system comprising a memory having instructions that, when executed by a processor, causes the processor to display on a display device a source location of an acoustic wave on an image captured by a camera sensor using information from capacitively coupled circuits that are in communication with transducers disposed adjacent to the camera sensor.

### TECHNICAL FIELD

The subject matter described herein relates, in general, to sound direction sensor-based acoustic cameras and related systems and methods.

### BACKGROUND

The background description provided is to present the context of the disclosure generally. Work of the inventor, to the extent it may be described in this background section, and aspects of the description that may not otherwise qualify as prior art at the time of filing, are neither expressly nor impliedly admitted as prior art against the present technology.

Traditional acoustic cameras combine an optical camera with an array of microphones strategically positioned around it. Their functionality relies on detecting and processing the phase differences of incoming acoustic waves, enabling the localization of sound sources. However, for accurate phase analysis, the microphones must be spaced relatively far apart to capture meaningful variations in wave propagation.

This spacing requirement, while essential for precise sound imaging, introduces significant design challenges. The increased distance between microphones necessitates a larger framework, leading to systems that are often bulky and complex. As a result, traditional acoustic cameras can be cumbersome to deploy, limiting their practicality in applications that demand compact, portable, or seamlessly integrated solutions.

### SUMMARY

This section generally summarizes the disclosure and is not a comprehensive explanation of its full scope or all its features.

In one embodiment, a device includes a camera sensor and transducers disposed adjacent to the camera sensor. The transducers are configured to be connected to one or more capacitively coupled circuits.

In another embodiment, a system includes a memory having instructions that, when executed by a processor, causes the processor to display on a display device a source location of an acoustic wave on an image captured by a camera sensor using information from capacitively coupled circuits that are in communication with transducers disposed adjacent to the camera sensor.

In another embodiment, a method includes the step of displaying on a display device a source location of an acoustic wave on an image captured by a camera sensor using information from capacitively coupled circuits that are in communication with transducers disposed adjacent to the camera sensor.

Further areas of applicability and various methods of enhancing the disclosed technology will become apparent from the description provided. The description and specific examples in this summary are intended for illustration only and are not intended to limit the scope of the present disclosure.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements, or multiple elements may be designed as one element. In some embodiments, an element shown as an internal component of another element may be implemented as an external component and vice versa. Furthermore, elements may not be drawn to scale.

FIG. 1 illustrates a scenario where an acoustic camera utilizes one or more capacitively coupled circuits that can determine the source location of an acoustic wave.

FIG. 2 illustrates a system that incorporates the acoustic camera of FIG. 1 that can determine the source location of an acoustic wave.

FIGS. 3A and 3B illustrate examples of the capacitively coupled circuits that may be utilized with the acoustic camera of FIG. 1.

FIG. 4 illustrates a data acquisition system that may be utilized with the system of FIG. 2 to determine the source location of an acoustic wave.

FIG. 5 illustrates a method for determining the source location of an acoustic wave utilizing the acoustic camera of FIG. 1.

FIGS. 6A and 6B illustrate examples of voltages that may be output by the capacitively coupled circuits that may be utilized with the acoustic camera of FIG. 1.

### DETAILED DESCRIPTION

Described herein are acoustic cameras and related systems and methods that utilize capacitively coupled circuits. Moreover, in one example, an acoustic camera includes a camera sensor and transducers disposed adjacent to the camera sensor. The transducers are configured to be connected to one or more capacitively coupled circuits. A data acquisition system utilizes information generated by the capacitively coupled circuits to determine an azimuth angle and an elevation angle of the source location of an acoustic wave with respect to the camera sensor. Using this information, the data acquisition device may then display on a display device the source location of the acoustic wave on an image captured by the camera sensor.

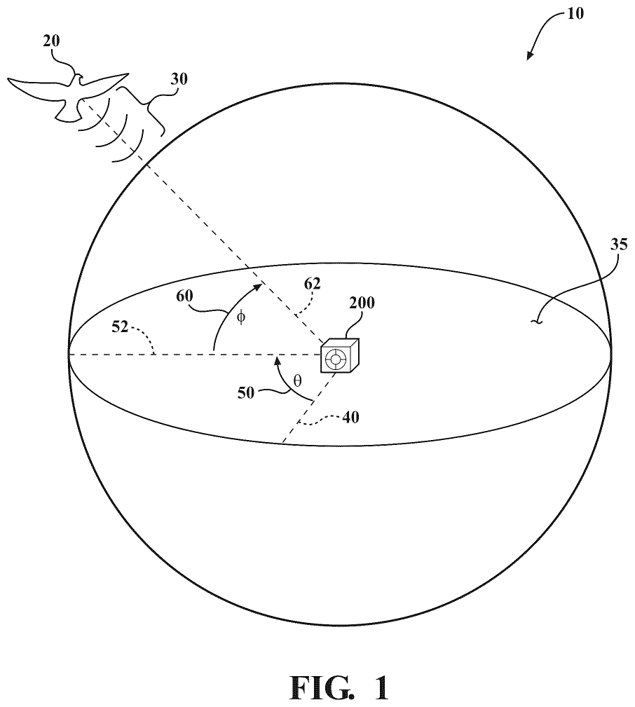

To better illustrate this concept, reference is made to FIG. 1, which illustrates an example scenario 10, which includes an acoustic camera 200 that includes an image sensor and transducers located adjacent to the camera sensor. A more detailed view of the acoustic camera 200 and the image sensors and transducers will be provided in the later figures and described in the paragraphs that follow. Here, also shown is an acoustic wave 30 that was produced by a sound source 20. In this example, the sound source 20 is in the form of an eagle that has produced the acoustic wave 30 by emitting an acoustic call.

As will be described in the paragraphs that follow, the acoustic camera 200 is capable of capturing images, including images that may include the sound source 20. In addition, the acoustic camera 200 has transducers that can detect and output information regarding the acoustic wave 30. Information output from the transducers will be provided to one or more capacitively coupled circuits that, in turn, provide information to a data acquisition device that can determine the azimuth angle 50 and the elevation angle 60 of the sound source 20 with respect to a camera sensor of the acoustic camera 200.

Moreover, the azimuth angle 50 is the angle between line 40, defined by the forward view of the camera sensor of the acoustic camera 200, and the line 52, which indicates the direction of the sound source 20 along the horizontal plane 35. The elevation angle 60 is the angle between line 52 and the line of sight 62 of the sound source 20, which is above the horizontal plane 35. Once the azimuth angle 50 and the elevation angle 60 are determined, the data acquisition device can display on a display device the image captured by the acoustic camera 200 that includes the sound source 20 and an indication of where the sound source is on the captured image.

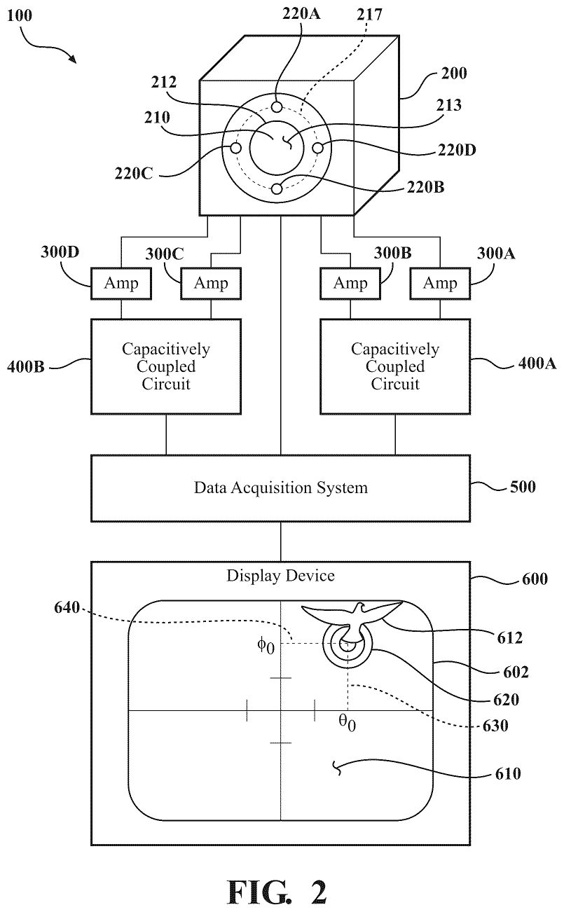

Referring to FIG. 2, illustrated is a more detailed view of a system that includes the acoustic camera 200, amplifiers 300A-300D, capacitively coupled circuits 400A and 400B, a data acquisition system 500, and a display device 600. In this example, the acoustic camera 200, as explained earlier, includes an image sensor 210 capable of capturing images. The image sensor 210 captures images by converting light into electronic signals to create the image. The image sensor 210 can be any type of image sensor, such as a charge-coupled device (“CCD”) and/or a complementary metal-oxide-semiconductor (“CMOS”) sensor. Further, the image sensor 210 can capture images across a variety of different spectrums, not just the visible spectrum. For example, the image sensor 210 may also be able to capture infrared or ultraviolet images.

The image sensor 210 may define a perimeter 212, which generally surrounds the image sensor 210. In some cases, the perimeter 212 of the image sensor 210 may be defined by a lens 213 or a protective structure for protecting the image sensor 210 from damage. Located adjacent to the image sensor 210 and/or the perimeter 212 may be transducers 220A-220D. The transducers 220A-220D may be disposed of along the perimeter 212 such that they are equally spaced apart from each other. When configured as such, the transducers 220A and 220B are generally located on opposing sides of the image sensor 210 and oppose each other. In like manner, the transducers 220C and 220D are also generally located on opposing sides of the image sensor 210 and oppose each other. As such, if a circle 217 is fit around the transducers 220A-220D, each of the transducers 220A-220D would be located approximately 90°apart from each other along the circle 217 with the transducers 220A and 220B being 180° apart from each other and the transducers 220C and 220D being 180° apart from each other.

As will be explained later, the transducers 220A and 220B generate signals that are used to determine the elevation angle 60, while the transducers 220C and 220D generate signals that are used to determine the azimuth angle 50. As such, the transducers 220A and 220B can be paired together to determine the elevation angle 60, while the transducers 220C and 220D can be paired together to determine the azimuth angle 50.

The transducers 220A-220D can take any one of a number of different forms. In one example, the transducers 220A-220D may be any device that converts mechanical and/or sound energy into electrical signals. Moreover, the transducers 220A-220D operate based on the principle of transduction, where one form of energy is transformed into another. As such, the transducers 220A-220D may be microphones that convert acoustic waves into electrical signals. In one example, the transducers 220A-220D may be micro-electro-mechanical system (“MEMS”) microphones. A MEMS microphone is a small, pressure-sensitive microphone created using semiconductor technology. It may include a diaphragm etched into a silicon wafer, which moves in response to sound waves. This movement creates an electrical signal that can be amplified and converted into digital data.

The signals outputted by the transducers 220A-220D may be amplified by amplifiers 300A-300D, respectively, to amplify the signals. Moreover, the amplifiers 300A-300D may boost low-level audio signals, such as those outputted by the transducers 220A-220D, to a higher level. The amplifiers 300A-300D may enhance the power of the audio signals outputted by the transducers 220A-220D without significantly altering their original quality.

The amplified signals from the amplifiers 300A and 300B are then provided to a capacitively coupled circuit 400A, while the amplified signals from the amplifiers 300C and 300D are provided to a capacitively coupled circuit 400B. Each of the capacitively coupled circuits 400A and 400B, as will be explained later, includes two different circuits (sometimes referred to as different stages) that are connected to each other utilizing a capacitor. This type of coupling isolates the different circuits and prevents direct current (“DC”) bias.

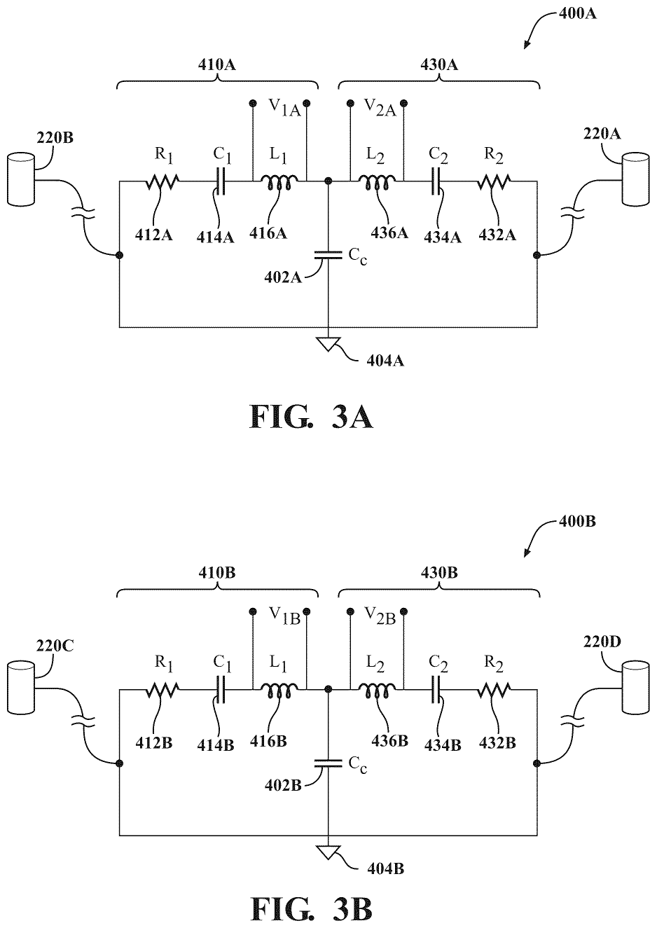

FIG. 3 illustrates one example of the capacitively coupled circuit 400A. Here, the capacitively coupled circuit 400A includes a first circuit 410A and a second circuit 430A that are connected to each other via a connecting capacitor 402A (C_{C}). The first circuit 410A and the second circuit 430A may be substantially equal (i.e., within 10%) to each other and include the same components having the same parameters (i.e., such as the same (within 10%) inductance, resistance, and capacitance.)

Moreover, the first circuit 410A may be an inductor-resistor-capacitor circuit that includes a resistor 412A (R₁), a capacitor 414A (C₁), and an inductor 416A (L₁) that are connected in series, wherein the inductor 416A (L₁) is connected to the connecting capacitor 402A (C_{C}), and the resistor 412A (R₁) is connected to ground 404A. Similarly, the second circuit 430A may be an inductor-resistor-capacitor circuit that includes a resistor 432A (R₂), a capacitor 434A (C₂), and an inductor 436A (L₂) that are connected in series, wherein the inductor 436A (L₂) is connected to the connecting capacitor 402A (C_{C}), and the resistor 432A (R₂) is connected to ground 404A. The resistance of the resistors 412A (R₁) and 432A (R₂), the capacitance of the capacitors 414A (C₁) and 434A (C₂), and the inductance of the inductors 416A and 436A (L₂) may be substantially equal to one another. As such, the resistors 412A (R₁) and 432A (R₂) may have the same resistance, the capacitors 414A (C₁) and 434A (C₂) may have the same capacitance, and the inductors 416A and 436A may have the same inductance. Generally, the capacitance of the connecting capacitor 402A (C_{C}) may be greater than that of the capacitors 414A (C₁) and/or 434A (C₂). In one example, the capacitance of the connecting capacitor 402A (C_{C}) may be approximately five times greater than the capacitance of the capacitors 414A (C₁) and/or 434A (C₂).

The transducer 220A, via the amplifier 300A, is connected between the second circuit 430A and the ground 404A. In like manner, the transducer 220B is connected between the first circuit 410A and the ground 404A. When the acoustic wave 30 is detected by the transducers 220A and 220B, voltages V_{1A} and V_{2A} are generated across the inductors 416A and 436A, respectively. As will be explained in the paragraphs that follow, the voltages V_{1A} and V_{2A} will be utilized by the data acquisition system 500 to determine the elevation angle 60 of the sound source 20 with respect to the image sensor 210 of the acoustic camera 200.

FIG. 3B illustrates one example of the capacitively coupled circuit 400B, which is substantially similar to the capacitively coupled circuit 400A, except as noted otherwise. Here, the capacitively coupled circuit 400B includes a first circuit 410B and a second circuit 430B, which are connected to each other via a connecting capacitor 402B (C_{C}). The first circuit 410B and the second circuit 430B may be substantially equal (i.e., within 10%) to each other and include the same components having the same parameters (i.e., such as the same (within 10%) inductance, resistance, and capacitance.)

Moreover, the first circuit 410B may be an inductor-resistor-capacitor circuit that includes a resistor 412B (R₁), a capacitor 414B (C₁), and an inductor 416B (L₁) that are connected in series, wherein the inductor 416B (L₁) is connected to the connecting capacitor 402B (C_{C}), and the resistor 412B (R₁) is connected to ground 404B. Similarly, the second circuit 430B may be an inductor-resistor-capacitor circuit that includes a resistor 432B (R₂), a capacitor 434B (C₂), and an inductor 436B (L₂) that are connected in series, wherein the inductor 436B (L₂) is connected to the connecting capacitor 402B (C_{C}), and the resistor 432B (R₂) is connected to ground 404B. The resistance of the resistors 412B (R₁) and 432B (R₂), the capacitance of the capacitors 414B (C₁) and 434B (C₂), and the inductance of the inductors 416B and 436B (L₂) may be substantially equal to one another. As such, the resistors 412B (R₁) and 432B (R₂) may have the same resistance, the capacitors 414B (C₁) and 434B (C₂) may have the same capacitance, and the inductors 416B and 436B may have the same inductance. Generally, the capacitance of the connecting capacitor 402B (C_{C}) may be greater than that of the capacitors 414B (C₁) and/or 434B (C₂). In one example, the capacitance of the connecting capacitor 402B (C_{C}) may be approximately five times greater than the capacitance of the capacitors 414B (C₁) and/or 434A (C₂).

As mentioned before, the capacitively coupled circuits 400A and 400B may be substantially similar to each other and, therefore, may utilize similar electrical components having similar specifications. As such, the resistance of the resistors 412A, 412B, 432A, and 432B, the capacitance of the capacitors 414A, 414B, 434A, and 434B, and the inductance of the inductors 416A, 416B, 436A, and 436B may be substantially equal to one another. Further still, the capacitance of the connecting capacitors 402A and 402B may also be substantially similar.

The transducer 220C, via the amplifier 300C, is connected between the first circuit 410B and the ground 404B. In like manner, the transducer 220D is connected between the second circuit 430B and the ground 404B. When the acoustic wave 30 is detected by the transducers 220C and 220D, voltages V_{1B} and V_{2B} are generated across the inductors 416B and 436B, respectively. As will be explained in the paragraphs that follow, the voltages V_{1B} and V_{2B} will be utilized by the data acquisition system 500 to determine the azimuth angle 50 of the sound source 20 with respect to the image sensor 210 of the acoustic camera 200.

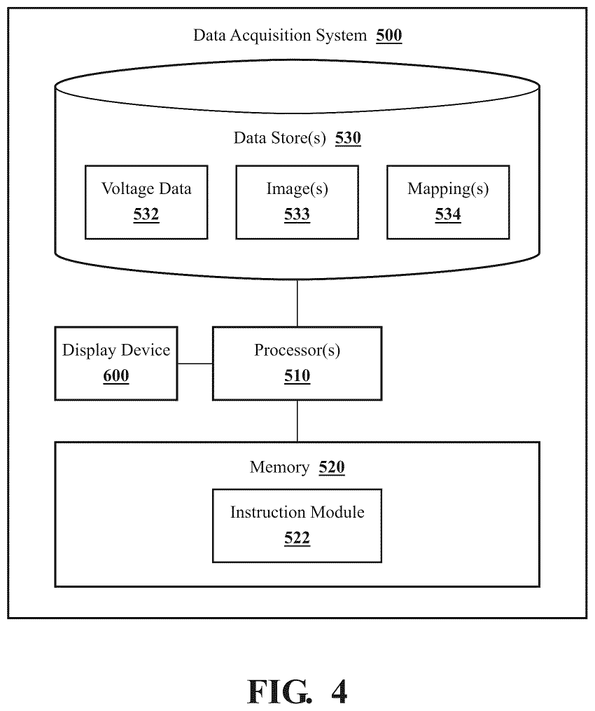

FIG. 4 illustrates a more detailed view of the data acquisition system 500 that will be utilized to determine the location of the sound source 20 of the acoustic wave 30 of FIG. 1 with respect to the image sensor 210 of the acoustic camera 200. It should be understood that the data acquisition system 500 is just one example that the data acquisition system 500 may take. As such, the data acquisition system 500 may have more, fewer, or even different components than those illustrated in FIG. 4.

Here, in this example, the data acquisition system 500 includes one or more processor(s) 510. Accordingly, the processor(s) 510 may be a part of the data acquisition system 500, or the data acquisition system 500 may access the processor(s) 510 through a data bus or another communication path. In one or more embodiments, the processor(s) 510 is an application-specific integrated circuit that is configured to implement functions associated with an instruction module 522. In general, the processor(s) 510 is an electronic processor, such as a microprocessor, which is capable of performing various functions as described herein.

The data acquisition system 500 may also include a display device 600 that is in communication with the processor(s) 510. The display device 600 may be incorporated within the data acquisition system 500 or may be external to the data acquisition system 500, as shown in FIG. 3. As best shown in FIG. 3, the display device 600 can include a display area 602 for displaying an image 610 captured by the image sensor 210 of the acoustic camera 200. As will be explained in greater detail later, in addition to displaying the image 610, the display device 600 may also display a representation 612 of the sound source, such as the sound source 20 of FIG. 1, which was previously stated to be an eagle, and an icon 620 representing the source of the sound. In this case, the icon 620 is placed over the representation 612 of the eagle, which produced the sound. The display device 600 may also display the azimuth angle 630 and/or the elevation angle 640 in the display area 602 as well.

Returning to FIG. 4, the data acquisition system 500 includes a memory 520 that stores instruction module 522. The memory 520 may be a random-access memory (RAM), read-only memory (ROM), a hard disk drive, a flash memory, or other suitable memory for storing the instruction module 522. The instruction module 522 is, for example, computer-readable instructions that, when executed by the processor(s) 510, cause the processor(s) 510 to perform the various functions disclosed herein.

Furthermore, in one example, the data acquisition system 500 includes a data store(s) 530. The data store(s) 530 is, in one embodiment, an electronic data structure such as a database that is stored in the memory 520 or another memory and that is configured with routines that can be executed by the processor(s) 510 for analyzing stored data, providing stored data, organizing stored data, and so on. Thus, in one embodiment, the data store(s) 530 stores data used by the instruction module 522 in executing various functions.

In this example, the data store(s) 530 may include voltage data 532 collected from the capacitively coupled circuits 400A and 400B. More specifically, this voltage data 532 includes V_{1A}, V_{2A}, V_{1B}, and V_{2B.}

Moreover, when the transducers 220A and 220B sense the acoustic wave 30, a signal will be generated by the transducers 220A and 220B, which is amplified by the amplifiers 300A and 300B. This then results in the voltages V_{1A} and V_{2A} being generated across the inductors 416A (L₁) and 436A (L₂), respectively. The voltages V_{1A} and V_{2A} are then saved as corresponding pairs in the voltage data 532.

In like manner, when the transducers 220C and 220D sense the acoustic wave 30, a signal will be generated by the transducers 220C and 220D, which is amplified by the amplifiers 300C and 300D. This then results in the voltages V_{1B} and V_{2B} being generated across the inductors 416B (L₁) and 436B (L₂), respectively. The voltages V_{1B} and V_{2B} are then saved as corresponding pairs in the voltage data 532.

The mapping(s) 534 may be in the form of a reference table that references (1) a particular ratio of a corresponding pair of voltages V_{1A} and V_{2A} to a particular angle, which indicates the elevation angle 60 of the sound source 20 with respect to the image sensor 210 of the acoustic camera 200 and (2) a particular ratio of a corresponding pair of voltages V_{1B} and V_{2B} to a particular angle, which indicates the azimuth angle 50 of the sound source 20 with respect to the acoustic camera 200. As such, by using the mapping(s) 534 and the voltage data 532, the azimuth angle 50 and the elevation angle 60 of the sound source 20 with respect to the image sensor 210 of the acoustic camera 200 can be determined. Thereafter, the azimuth angle 50 and the elevation angle 60 can be utilized to display the icon 620 on the display device 600, indicating the source of the acoustic wave 30.

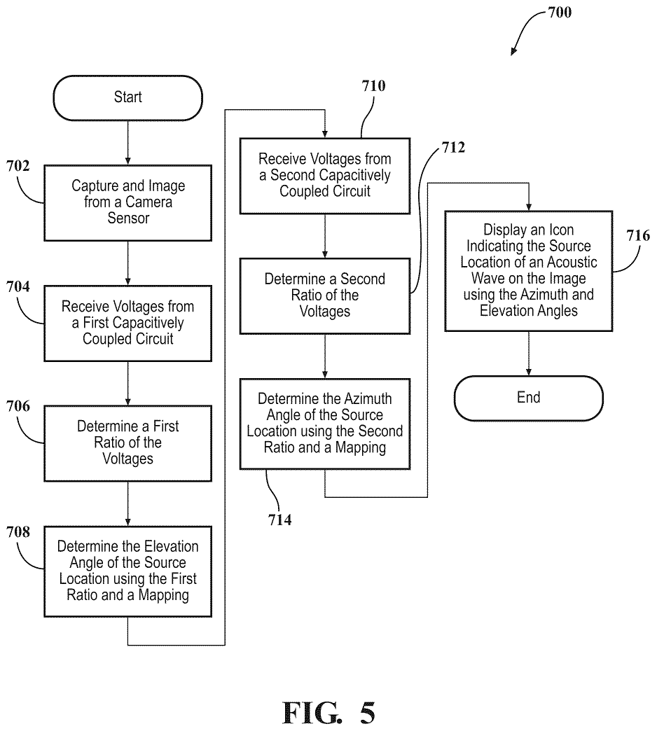

The instruction module 522 contains instructions that cause the processor(s) 510 to perform any of the methodologies described herein. With reference to FIG. 5, illustrated is a method 700 for determining the direction of the acoustic wave 30 using a capacitively coupled circuit. The method 700 will be described from the viewpoint of the system 100 in FIG. 2. However, it should be understood that this is just one example of implementing the method 700. While the method 700 is discussed in combination with the system 100, it should be appreciated that the method 700 is not limited to being implemented within the system 100 but is instead one example of a system that may implement the method 700. As such, the method 700 may be embodied within the instruction module 522 as processor-executable instructions that, when executed by the processor(s) 510, cause the processor(s) 510 to perform the method 700.

Moreover, in step 702, the instruction module 522 includes instructions that, when executed by the processor(s) 510, causes the processor(s) 510 to capture an image using the image sensor 210 of the acoustic camera 200. The image may be stored within the data acquisition system 500 as the image(s) 533.

In step 704, the instruction module 522 includes instructions that, when executed by the processor(s) 510, causes the processor(s) 510 to receive a voltage (V_{1A}) and a voltage (V_{2A}) from the capacitively coupled circuit 400A. Alternatively, instead of receiving the voltage (V_{1A}) and the voltage (V_{2A}) directly from the capacitively coupled circuit 400A, the voltage (V_{1A}) and the voltage (V_{2A}) may have been previously stored in the data store(s) 530 as the voltage data 532.

As mentioned before, the voltage (V_{1A}) may be the voltage across the inductor 416A of the first circuit 410A, while the voltage (V_{2A}) may be the voltage across the inductor 436A of the second circuit 430A. Generally, the voltage (V_{1A}) and the voltage (V_{2A}) may be corresponding pairs of voltages measured at or near the same time as the image captured in step 702 was performed. As such, the voltage (V_{1A}) and the voltage (V_{2A}) are the voltages generated by the capacitively coupled circuit 400A when the acoustic wave 30 is sensed by the transducers 220A and 220B. As mentioned before, the voltage (V_{1A}) and the voltage (V_{2A}) may be stored as pairs as the voltage data 532 in the data store(s) 530.

In step 706, the instruction module 522 includes instructions that, when executed by the processor(s) 510, causes the processor(s) 510 to determine a ratio between the voltage (V_{1A}) and the voltage (V_{2A}). In one example, this may be determined by simply dividing the voltage (V_{1A}) by the voltage (V_{2A}) or vice versa.

In step 708, the instruction module 522 includes instructions that, when executed by the processor(s) 510, cause the processor(s) 510 to determine the elevation angle 60. In one example, as mentioned before, the mapping(s) 534 may be a reference table or lookup table that can be used to reference a particular ratio to the elevation angle 60 of the sound source 20 of the acoustic wave 30 with respect to the image sensor 210 of the acoustic camera 200.

In step 710, the instruction module 522 includes instructions that, when executed by the processor(s) 510, causes the processor(s) 510 to receive a voltage (V_{1B}) and a voltage (V_{2B}) from the capacitively coupled circuit 400B. Alternatively, instead of receiving the voltage (V_{1B}) and the voltage (V_{2B}) directly from the capacitively coupled circuit 400B, the voltage (V_{1B}) and the voltage (V_{2B}) may have been previously stored in the data store(s) 530 as the voltage data 532.

As mentioned before, the voltage (V_{1B}) may be the voltage across the inductor 416B of the first circuit 410B, while the voltage (V_{2B}) may be the voltage across the inductor 436B of the second circuit 430B. Generally, the voltage (V_{1B}) and the voltage (V_{2B}) may be corresponding pairs of voltages measured at or near the same time as the image captured in step 702 was performed. As such, the voltage (V_{1B}) and the voltage (V_{2B}) are the voltages generated by the capacitively coupled circuit 400B when the acoustic wave 30 is sensed by the transducers 220C and 220D. As mentioned before, the voltage (V_{1B}) and the voltage (V_{2B}) may be stored as pairs as the voltage data 532 in the data store(s) 530.

In step 712, the instruction module 522 includes instructions that, when executed by the processor(s) 510, causes the processor(s) 510 to determine a ratio between the voltage (V_{1A}) and the voltage (V_{2A}). In one example, this may be determined by simply dividing the voltage (V_{1A}) by the voltage (V_{2A}) or vice versa.

In step 714, the instruction module 522 includes instructions that, when executed by the processor(s) 510, cause the processor(s) 510 to determine the azimuth angle 50. In one example, as mentioned before, the mapping(s) 534 may be a reference table or lookup table that can be used to reference a particular ratio to the azimuth angle 50 of the sound source 20 of the acoustic wave 30 with respect to the image sensor 210 of the acoustic camera 200.

In this example, the method 700 first determined the elevation angle 60 (steps 704-708) before determining the azimuth angle 50 (steps 710-714). However, it should be understood that the method 700 may determine the azimuth angle 50 before determining the elevation angle 60. Further still, it may be possible that the method 700 may be able to determine the azimuth angle 50 and the elevation angle 60 concurrently.

In step 716, the instruction module 522 includes instructions that, when executed by the processor(s) 510, cause the processor(s) 510 to display the icon 620 in the display area 602 of the display device 600, such that the icon 620 indicates the location of the sound source 20 that produces the acoustic wave 30. This is accomplished by utilizing the azimuth angle 50 and the elevation angle 60, which generally indicates the direction of the sound source 20 that produces the acoustic wave 30 with respect to the image sensor 210 of the acoustic camera 200. As best shown in FIG. 2, the icon 620 may be overlaid on a displayed image 610 of the image captured by the image sensor 210 of the acoustic camera 200 at step 702. As such, the icon 620 can indicate the location within the displayed image 610 of the sound source 20 of the acoustic wave 30.

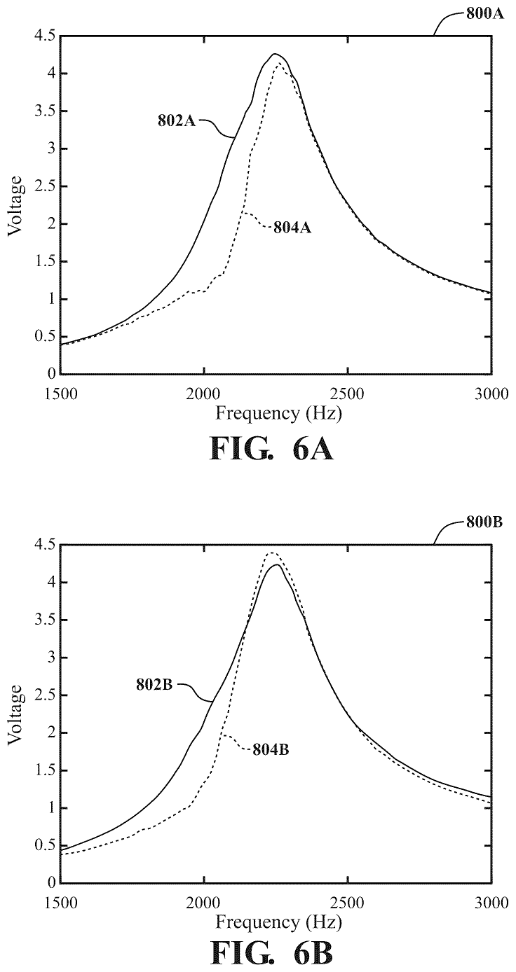

To better understand how a comparison (e.g., the ratio) of the voltage (V_{1A}) and the voltage (V_{2A}) is utilized to determine the elevation angle 60, reference is made to FIG. 6A. Moreover, FIG. 6A illustrates a chart 800A showing the value 802A of the voltage (V_{1A}) and the value 804A of the voltage (V_{2A}) across a frequency range of 1500-3000 Hz at a known angle. Here, the mapping(s) 534 essentially provides a numerical value regarding the elevation angle 60 with the ratios of the voltage (V_{1A}) and the voltage (V_{2A}) across a range of frequencies. As such, when one knows the ratio between the voltage (V_{1A}) and the voltage (V_{2A}), the mapping(s) 534 can be utilized to determine the elevation angle 60.

Similarly, FIG. 6B illustrates a chart 800B showing the value 802B of the voltage (V_{1B}) and the value 804B of the voltage (V_{2B}) across a frequency range of 1500-3000 Hz at a known angle. Like before, the mapping(s) 534 essentially provides a numerical value regarding the azimuth angle 50 with the ratios of the voltage (V_{1B}) and the voltage (V_{2B}) across a range of frequencies. As such, when one knows the ratio between the voltage (V_{1A}) and the voltage (V_{2A}), the mapping(s) 534 can be utilized to determine the azimuth angle 50.

Detailed embodiments are disclosed herein. However, it is to be understood that the disclosed embodiments are intended only as examples. Therefore, specific structural and functional details disclosed herein are not to be interpreted as limiting but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in the figures. The embodiments are not limited to the illustrated structure or application.

The systems, components and/or processes described above can be realized in hardware or a combination of hardware and software and can be realized in a centralized fashion in one processing system or in a distributed fashion where different elements are spread across several interconnected processing systems. Any processing system or another apparatus adapted for carrying out the methods described herein is suited. A typical combination of hardware and software can be a processing system with computer-usable program code that, when being loaded and executed, controls the processing system such that it carries out the methods described herein. The systems, components, and/or processes also can be embedded in a computer-readable storage, such as a computer program product or other data programs storage device, readable by a machine, tangibly embodying a program of instructions executable by the machine to perform methods and processes described herein. These elements also can be embedded in an application product that comprises all the features enabling the implementation of the methods described herein and which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the preceding. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the preceding. In the context of this document, a computer-readable storage medium may be any tangible medium that can contain or store a program for use by or in connection with an instruction execution system, apparatus, or device.

Generally, module as used herein includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the preceding. Computer program code for carrying out operations for aspects of the present arrangements may be written in any combination of one or more programming languages, including an object-oriented programming language such as Java™, Smalltalk, C++, or the like, and conventional procedural programming languages, such as the “C” programming language or similar programming languages. The program code may execute entirely on the user's computer, partly on the user's computer, as a stand-alone software package, and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . .” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

Aspects herein can be embodied in other forms without departing from the spirit or essential attributes thereof. Accordingly, reference should be made to the following claims rather than to the preceding specification, indicating the scope hereof.

What is claimed is:

1. A device comprising:
a camera sensor; and
transducers disposed adjacent to the camera sensor and configured to be connected to a capacitively coupled circuit.

2. The device of claim 1, wherein the transducers are equally spaced apart from each other along a perimeter defined by the camera sensor.

3. The device of claim 2, wherein the transducers include a first pair of transducers and a second pair of transducers, wherein the transducers forming the first pair of transducers oppose each other along the perimeter and wherein the transducers forming the second pair of transducers oppose each other along the perimeter.

4. The device of claim 3, wherein the capacitively coupled circuit includes two capacitively coupled circuits, wherein one of the capacitively coupled circuits is connected to the first pair of transducers and the other capacitively coupled circuit is connected to the second pair of transducers.

5. The device of claim 1, wherein the capacitively coupled circuit comprises a first circuit and a second circuit that are inductor-resistor-capacitor circuits.

6. A system comprising a memory having instructions that, when executed by a processor, causes the processor to display on a display device a source location of an acoustic wave on an image captured by a camera sensor using information from capacitively coupled circuits that are in communication with transducers disposed adjacent to a camera sensor.

7. The system of claim 6, wherein the transducers are equally spaced apart from each other along a perimeter defined by the camera sensor.

8. The system of claim 6, wherein the transducers include a first pair of transducers and a second pair of transducers, wherein the transducers forming the first pair of transducers oppose each other along a perimeter defined by the camera sensor and wherein the transducers forming the second pair of transducers oppose each other along the perimeter.

9. The system of claim 8, wherein one of the capacitively coupled circuits is connected to the first pair of transducers and the other capacitively coupled circuit is connected to the second pair of transducers.

10. The system of claim 6, wherein each of the capacitively coupled circuits comprise a first circuit and a second circuit that are inductor-resistor-capacitor circuits.

11. The system of claim 6, wherein the memory further includes instructions that, when executed by the processor, cause the processor to:
determine an azimuth angle and an elevation angle of the source location with respect to the camera sensor using information from the capacitively coupled circuits that are in communication with the transducers disposed adjacent to the camera sensor; and
determine the source location to display on the display device using the azimuth angle and the elevation angle.

12. The system of claim 11, wherein the memory further includes instructions that, when executed by the processor, cause the processor to determine the azimuth angle of the source location using a ratio between a first voltage from a first circuit and a second voltage of a second circuit of one of the capacitively coupled circuits and a mapping that maps the ratio to the azimuth angle.

13. The system of claim 11, wherein the memory further includes instructions that, when executed by the processor, cause the processor to determine the elevation angle of the source location using a ratio between a first voltage from a first circuit and a second voltage of a second circuit of one of the capacitively coupled circuits and a mapping that maps the ratio to the elevation angle.

14. A method comprising displaying on a display device a source location of an acoustic wave on an image captured by a camera sensor using information from capacitively coupled circuits that are in communication with transducers disposed adjacent to the camera sensor.

15. The method of claim 14, wherein the transducers are equally spaced apart from each other along a perimeter defined by the camera sensor.

16. The method of claim 14, wherein the transducers include a first pair of transducers and a second pair of transducers, wherein the transducers forming the first pair of transducers oppose each other along a perimeter defined by the camera sensor and wherein the transducers forming the second pair of transducers oppose each other along the perimeter.

17. The method of claim 16, wherein one of the capacitively coupled circuits is connected to the first pair of transducers and the other capacitively coupled circuit is connected to the second pair of transducers.

18. The method of claim 14, wherein each of the capacitively coupled circuits comprise a first circuit and a second circuit that are inductor-resistor-capacitor circuits.

19. The method of claim 14, further comprising:
determining an azimuth angle and an elevation angle of the source location with respect to the camera sensor using information from the capacitively coupled circuits that are in communication with the transducers disposed adjacent to the camera sensor; and
determining the source location to display on the display device using the azimuth angle and the elevation angle.

20. The method of claim 19, further comprising determining at least one of the azimuth angle and the elevation angle using a ratio between a first voltage from a first circuit and a second voltage of a second circuit of one of the capacitively coupled circuits and a mapping that maps the ratio to at least one of the azimuth angle and the elevation angle.
